(19) United States
(12) Patent Application Publication
(10) Pub. No.: US 2026/0065463 A1
(43) Pub. Date: Mar. 5, 2026

(54) METHOD AND DEVICE FOR DETECTING DEFECTS ON WAFER SURFACE

(71) Applicant: Samsung Electronics Co., Ltd, Suwon-si (KR)

(72) Inventors: Kee Chang LEE, Suwon-si (KR); YOUNHWA KANG, Suwon-si (KR); Yoonseok KO, Suwon-si (KR); Jung Hoon LEE, Suwon-si (KR); Sang Soo JEE, Suwon-si (KR)

(21) Appl. No.: 19/276,392

(22) Filed: Jul. 22, 2025

(30) Foreign Application Priority Data
Aug. 28, 2024 (KR) 10-2024-0115856

(51) Int. Cl. G06T 7/00; G06T 5/40; G06T 5/70; G06T 7/13; G06T 7/136

(52) U.S. Cl. CPC G06T 7/001; G06T 5/40; G06T 5/70; G06T 7/13; G06T 7/136; G06T 2207/20004; G06T 2207/20021; G06T 2207/30148

(57) ABSTRACT

A method for detecting defects on the wafer surface includes receiving a wafer image obtained by capturing a wafer in grayscale or monochromatic expression, determining a uniformity of contrast distribution of the wafer image, detecting n detailed regions separated within the wafer image and performing adaptive image binarization on the n detailed regions when the contrast distribution of the wafer image is determined to be uniform, where n is a natural number, detecting m detailed regions separated within the wafer image and performing adaptive image equalization on the m detailed regions when the contrast distribution of the wafer image is determined to be non-uniform, where m is a natural number, performing edge detection on the wafer image to detect an edge pixel, and performing line detection on the wafer image based on the edge pixel to detect a scratch on the surface of the wafer.

This application claims priority to Korean Patent Application No. 10-2024-0115856, filed on Aug. 28, 2024, and all the benefits accruing therefrom under 35 U.S.C. § 119, the content of which in its entirety is herein incorporated by reference.

### BACKGROUND

### (1) Field

The present disclosure relates to a method and device for detecting defects on a wafer surface.

### (2) Description of the Related Art

In the semiconductor manufacturing process, quality control of a wafer surface treated with a chemical mechanical polishing (CMP) process may have a significant impact on the performance and reliability of the final product. Therefore, a method for efficiently detecting scratches that may occur on the wafer surface is essential. While human visual inspection of the wafer image may be used to determine the extent of scratches, or analytical instruments such as Fourier transform infrared spectroscopy (FTIR) or Raman spectroscopy may be used to identify foreign substances that may be present on the wafer, these methods have limitations.

### SUMMARY

The process of visually analyzing images is not only very time-consuming, but also relies on the subjective determination of the operator, which can result in low accuracy, especially since the results are not guaranteed to be consistent and there is a high possibility of missing fine scratches depending on the operator's fatigue and experience. In addition, in order to inspect the entire wafer surface, high-resolution images must be taken and partially enlarged for examination, which can significantly increase inspection time and the burden on operator. In some cases, multiple images captured in small sizes need to be analyzed one by one, which can reduce work efficiency. Eventually, these inspection methods are inefficient in mass production environments and struggle to meet the requirements of rapidly changing semiconductor technology. Therefore, a method for detecting scratches on the wafer surface in a more efficient and automated manner is desired.

Embodiments of the present disclosure provide a method and device for detecting defects on a wafer surface capable of detecting scratches on a wafer surface processed with a CMP process without human intervention in an efficient and automated manner.

A method for detecting defects on a wafer surface according to an embodiment includes receiving a wafer image obtained by capturing a wafer in a form in a grayscale or monochromatic expression, determining a uniformity of contrast distribution of the wafer image, detecting n detailed regions separated within the wafer image and performing adaptive image binarization on the n detailed regions when the contrast distribution of the wafer image is determined to be uniform, where n is a natural number, detecting m detailed regions separated within the wafer image and performing adaptive image equalization on the m detailed regions when the contrast distribution of the wafer image is determined to be non-uniform, where m is a natural number, performing edge detection on the wafer image to detect an edge pixel, and performing line detection on the wafer image based on the edge pixel to detect a scratch on the surface of the wafer.

In some embodiments, the performing the adaptive image binarization may include obtaining n local threshold values determined for each of the n detailed regions, and performing image binarization for each of the n detailed regions based on the n local threshold values.

In some embodiments, the performing the adaptive image binarization may further include receiving a first division variable having a predetermined value, dividing the wafer image based on the first division variable having the predetermined value, calculating the standard deviation of pixel brightness for each of divided regions of the wafer image divided based on the first division variable having the predetermined value, and determining each of the divided regions as the n detailed regions when standard deviations of all of the divided regions of the wafer image divided based on the first division variable having the predetermined value is less than a predetermined first threshold value.

In some embodiments, the performing the adaptive image binarization may further include increasing the value of the first division variable when the standard deviation of any one of the divided regions of the wafer image divided based on the first division variable having the predetermined value is equal to or greater than the first threshold value, dividing the wafer image based on the first division variable having an increased value, calculating the standard deviation of pixel brightness for each of divided regions of the wafer image divided based on the first division variable having the increased value, and determining each of the divided regions into the n detailed regions when the standard deviations of all of the divided regions of the wafer image divided based on the first division variable having the increased value is less than the first threshold value.

In some embodiments, the performing the adaptive image equalization may include obtaining m local threshold values determined for each of the m detailed regions, and performing image equalization for each of the m detailed regions based on the m local threshold values.

In some embodiments, the performing the adaptive image equalization may further include receiving a second division variable having a predetermined value, dividing the wafer image equally based on the second division variable having the predetermined value, calculating the standard deviation of pixel brightness for each of divided regions of the wafer image divided based on the second division variable having the predetermined value, and determining each of the divided regions as the m detailed regions when the standard deviations of all of the divided regions of the wafer image divided based on the second division variable having the predetermined value is less than a predetermined second threshold value.

In some embodiments, the performing the adaptive image equalization may further include increasing the value of the second division variable when the standard deviation of any one of the divided regions of the wafer image divided based on the second division variable having the predetermined value is equal to or greater than the second threshold value, dividing the wafer image based on the second division variable having an increased value, calculating the standard deviation of pixel brightness for each of divided regions of the wafer image divided based on the second division variable having the increased value, and determining each of the divided regions as the m detailed regions when the standard deviations of all of the divided regions of the wafer image divided based on the second division variable having the increased value is less than the predetermined second threshold value.

In some embodiments, the method may further include performing noise reduction on the wafer image before performing the adaptive image equalization when the contrast distribution of the wafer image is determined to be non-uniform may be further included.

In some embodiments, the determining the uniformity of contrast distribution of the wafer image may further include calculating pixel brightness for pixels in the wafer image, generating a histogram representing frequency of values for the pixel brightness, calculating an average and a standard deviation for the pixel brightness based on the histogram, determining that the contrast distribution of the wafer image is uniform when a value of the standard deviation is less than a predetermined third threshold value, and determining that the contrast distribution of the wafer image is non-uniform when the value of the standard deviation is equal to or greater than the third threshold value.

In some embodiments, the detecting of the edge pixel may include detecting the edge pixel obtained by performing edge detection based on a single gradient on the wafer image, on which the adaptive image binarization is performed, and by performing edge detection based on a variable gradient on the wafer image, on which the adaptive image equalization is performed.

A method for detecting defects on a wafer surface includes receiving a plurality of partial images obtained by dividing a wafer into a plurality of partial regions and capturing the plurality of partial regions, determining a uniformity of contrast distribution for a first partial image among the plurality of partial images, performing image binarization on the first partial image when it is determined that the contrast distribution of the first partial image is uniform, performing image equalization on the first partial image when it is determined that the contrast distribution of the first partial image is non-uniform, performing edge detection and line detection on the first partial image to detect a first scratch in the first partial image, determining the uniformity of contrast distribution for a second partial image different from the first partial image among the plurality of partial images, performing the image binarization on the second partial image when it is determined that the contrast distribution of the second partial image is uniform, performing the image equalization on the second partial image when it is determined that the contrast distribution of the second partial image is non-uniform, performing the edge detection and the line detection on the second partial image to detect a second scratch in the second partial image, and detecting a scratch on the surface of the wafer by merging the first scratch and the second scratch.

In some embodiments, the performing the image binarization on the first partial image may include detecting n₁ detailed regions separated within the first partial image and performing the image binarization for each of the n₁ detailed regions based on n₁ local threshold values determined for each of the n₁ detailed regions, where n₁ is a natural number, and the performing the image binarization on the second partial image may include detecting n₂ detailed regions separated within the second partial image, and performing the image binarization for each of the n₂ detailed regions based on n₂ local threshold values determined for each of the n₂ detailed regions, where n₂ is a natural number.

In some embodiments, the performing the image equalization on the first partial image may include detecting m₁ detailed regions separated within the first partial image, and performing the image equalization for each of the m₁ detailed regions based on m₁ local threshold values determined for each of the m₁ detailed regions, where m₁ is a natural number, and the performing the image equalization on the second partial image may include detecting m₂ detailed regions separated within the second partial image, and performing the image equalization for each of the m₂ detailed regions based on m₂ local threshold values determined for each of the m₂ detailed regions, where m₂ is a natural number.

In some embodiments, the method for detecting defects on the wafer surface may further include performing noise reduction on the first partial image before the performing the image equalization on the first partial image when the contrast distribution of the first partial image is determined to be non-uniform; and performing noise reduction on the second partial image before the performing the image equalization on the second partial image when the contrast distribution of the second partial image is determined to be non-uniform.

In some embodiments, the determining the uniformity of contrast distribution of the wafer image may include calculating pixel brightness for pixels in the first partial image or the second partial image, generating a histogram representing frequency of values for the pixel brightness, calculating an average and a standard deviation for the pixel brightness based on the histogram, determining that the contrast distribution of the first partial image or the second partial image is uniform when a value of the standard deviation is less than a predetermined threshold value, and determining that the contrast distribution of the first partial image or the second partial image is non-uniform when the value of the standard deviation is equal to or greater than the threshold value.

In some embodiments, the detecting the first scratch may include detecting the first scratch based on an edge pixel obtained by performing edge detection based on a single gradient on the first partial image, on which the image binarization is performed, and by performing edge detection based on a variable gradient on the first partial image, on which the image equalization is performed, and the detecting the second scratch may include detecting the second scratch based on an edge pixel obtained by performing edge detection based on a single gradient on the second partial image, on which the image binarization is performed, and performing edge detection based on a variable gradient on the second partial image, on which the image equalization is performed.

A device for detecting defects on a wafer surface according to an embodiment, which detects defects on a wafer surface includes one or more processors, and memory storing instructions that, when executed by the one or more processors, cause the device to receive a wafer image obtained by capturing a wafer in a form in grayscale or monochromatic expression, determine a uniformity of the contrast distribution of the wafer image, detect n detailed regions distinguished within the wafer image and perform adaptive image binarization on the n detailed regions when the contrast distribution of the wafer image is determined to be uniform, where n is a natural number, detect m detailed regions distinguished within the wafer image and perform adaptive image equalization on the m detailed regions when the contrast distribution of the wafer image is determined to be non-uniform, where m is a natural number, perform edge detection on the wafer image to detect an edge pixel, and perform line detection on the wafer image based on the edge pixel to detect a scratch on the surface of the wafer.

In some embodiments, the instructions, when executed by the one or more processors, further cause the device to perform noise reduction on the wafer image when the contrast distribution of the wafer image is determined to be non-uniform, before the adaptive image equalization is performed.

In some embodiments, the uniformity of the contrast distribution may be determined by calculating pixel brightness for pixels in the wafer image, generating a histogram representing frequency of values for the pixel brightness, calculating the average and standard deviation for the pixel brightness based on the histogram, determining that the contrast distribution of the wafer image is uniform when a value of the standard deviation is less than a predetermined third threshold value, and determining that the contrast distribution of the wafer image is non-uniform when the value of the standard deviation is equal to or greater than the third threshold value.

In some embodiments, the edge pixel may be detected by performing the edge detection based on a single gradient on the wafer image, on which the adaptive image binarization is performed, and by performing the edge detection based on a variable gradient on the wafer image, on which the adaptive image equalization is performed.

### BRIEF DESCRIPTION OF THE DRAWINGS

FIG. 1 illustrates a device for detecting defects on a wafer surface according to an embodiment.

FIGS. 2 to 7 illustrate specific processes for detecting defects on a wafer surface according to embodiments.

FIG. 8 illustrates a method for detecting defects on a wafer surface according to an embodiment.

FIG. 9 illustrates a method for detecting defects on a wafer surface according to an embodiment.

FIG. 10 illustrates a method for detecting defects on a wafer surface according to an embodiment.

FIG. 11 illustrates a method for detecting defects on a wafer surface according to an embodiment.

FIG. 12 illustrates a method for detecting defects on a wafer surface according to an embodiment.

FIG. 13 illustrates a method for detecting defects on a wafer surface according to an embodiment.

FIGS. 14 to 19 illustrate implementations of detecting defects on a wafer surface according to embodiments.

FIG. 20 illustrates a computing device according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Terms in the disclosure such as “unit,” “module” or the like indicate a unit processing at least one or more functions or operations, and these functions or operations can be implemented by hardware, software or a combination thereof. Additionally, at least some of the configurations or functions of the methods and devices for detecting defects on a wafer surface according to embodiments described below may be implemented as a program or software, and the program or software may be stored in a computer-readable medium.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

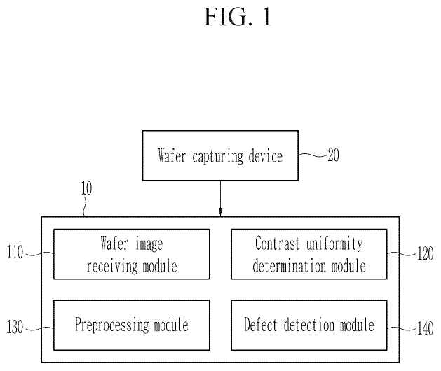

FIG. 1 illustrates a device for detecting defects on a wafer surface according to an embodiment.

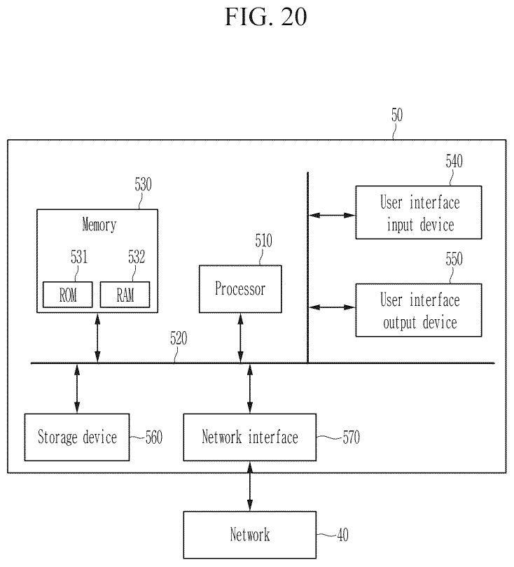

Referring to FIG. 1, a device for detecting defects on a wafer surface 10 according to an embodiment may execute program codes or instructions stored or loaded into one or more memory devices through one or more processors. In an embodiment, for example, the device for detecting defects on the wafer surface 10 may be implemented with a computing device 50 such as that described below with reference to FIG. 20. In this case, one or more processors may correspond to a processor 510 of the computing device 50, and one or more memory devices may correspond to a memory 530 of the computing device 50. Program code or instructions may, when executed by the one or more processors, cause the device to detect defects on the surface of a wafer. In this specification, the term “module” is used to logically separate the functions performed by program code or instructions.

A chemical mechanical polishing (CMP) process may be used or performed to planarize the surface of a semiconductor wafer and remove undesired materials. Specifically, during the semiconductor manufacturing process, multiple layers of thin films are stacked, and if the surface of each layer is not smooth, problems may occur in subsequent processes, so it is desired to planarize the surface of the wafer through the CMP process. Additionally, the CMP process may be performed to remove excessively accumulated thin film or excess material.

That is, the CMP process polishes the wafer surface through chemical reaction and mechanical polishing, and the slurry is a chemical solution containing an abrasive that reacts with specific substances on the wafer surface to remove the specific substances, thereby selectively polishing materials on the wafer surface. In an embodiment, the pad may provide mechanical polishing by rubbing the wafer while rotating. However, if particle contamination occurs in the slurry or pad, or if the size or concentration of the abrasive particles in the slurry is not uniform, scratches may occur on the wafer surface. Additionally, scratches may occur on the wafer surface if uneven pressure is applied to the wafer surface due to hardened or worn pads or setup errors in the CMP equipment. In the case of minor scratches, rework such as performing the CMP process again may be possible, or if the scratches themselves do not have a significant functional impact, the wafer may be manufactured into a lower grade product and used for other purposes, but if the scratches are severe enough to significantly impact the performance of the wafer or if rework is impossible, the wafer may be scrapped. Therefore, detecting scratches occurring on the wafer surface is an important procedure, such that a time-efficient and high-performance automated method may be desired.

An embodiment of the device for detecting defects on the wafer surface 10 may include a wafer image receiving module 110, a contrast uniformity determination module 120, a preprocessing module 130, and a defect detection module 140 to detect scratches on a wafer surface processed by the CMP process in an efficient and automated manner without human intervention.

The wafer image receiving module 110 may receive a wafer image obtained by capturing the wafer. In some embodiments, the wafer image receiving module 110 may receive a wafer image from a wafer capturing device 20. In some embodiments, the wafer capturing device 20 may include an atomic force microscope (AFM), an electron microscope, or the like, which is capable of capturing the surface of a wafer with high resolution. The AFM is a microscope that may measure the interatomic forces on the wafer surface to visualize the three-dimensional structure of the surface, thereby providing atomic-level resolution, and may be used to analyze the fine surface structure or defects of a wafer. In the disclosure, electron microscopy is a technology capable of checking the wafer surface using an electron beam, and it is possible to check the fine surface structure or defects of the wafer by analyzing the signal generated after scanning an electron beam on the surface of a wafer using a scanning electron microscope (SEM). If desired, a transmission electron microscope (TEM) may be used for internal analysis of the wafer.

The wafer image receiving module 110 may receive a wafer image in grayscale or monochromatic expression. A grayscale image may be an image that consists only of brightness information, without any information about color. Here, an image expressed in a single color (or monotone image) may be an image that expresses brightness differences based on a single color (e.g., red). In an embodiment, when the provided wafer image is a color image, the wafer image receiving module 110 may convert the color image into a grayscale image or a single-color image.

The contrast uniformity determination module 120 may determine the uniformity of contrast distribution (or contrast uniformity) of the wafer image provided to the wafer image receiving module 110. The uniformity of contrast distribution may be a measure of how evenly the brightness, or contrast, is distributed throughout the image.

The captured wafer image may contain spots depending on the performance of the capturing equipment or the physical characteristics of the wafer itself. In an embodiment, for example, stains may be caused by uneven structures on the wafer surface or by resolution limitations of the imaging equipment, and may be a major cause for the difficulty in detecting scratches. Examples of possible causes of such strains include cases where the wafer cross-section has non-uniform characteristics greater than the resolution of the capturing equipment, or where there is a problem with the alignment between the capturing equipment and the wafer. If the wafer image is not non-uniform and the non-scratch region is captured cleanly in a single color, the scratch region may be easily detected, but most wafer images may have non-scratch regions with non-uniform color or contrast. The non-uniformity makes the boundary between the scratched and non-scratched regions in the wafer image unclear, making it difficult for existing scratch detection methods to produce accurate results. The device for detecting defects on the wafer surface 10 may overcome such limitation by first quantitatively determining the degree of non-uniformity of the wafer image through the contrast uniformity determination module 120, and then applying different preprocessing to the wafer image through the preprocessing module 130 based on the determination through the contrast uniformity determination module 120.

In some embodiments, the contrast uniformity determination module 120 may calculate pixel brightness for all pixels in the wafer image and generate a histogram representing frequency of values for pixel brightness. Accordingly, the histogram may represent the number of pixels corresponding to each brightness level in a wafer image. In an embodiment, for example, the x-axis of the histogram may represent the pixel brightness values from 0 to 255 in the wafer image, and the y-axis may represent the number of pixels with the corresponding brightness in the wafer image. The more widely the histogram is distributed throughout the image, rather than clustered in a specific section, the larger the standard deviation and the less uniform the contrast of the wafer image.

In some embodiments, the contrast uniformity determination module 120 may calculate the average and standard deviation for pixel brightness based on the histogram. The average represents the center of brightness values throughout the wafer image, and may be calculated, for example, by summing the number of pixels H(i) corresponding to each brightness value i multiplied by i, and then dividing by the total number of pixels N in the wafer image. The standard deviation represents how much each brightness value is spread from the average, and may be calculated, for example, by calculating the square of the mean minus the square of each brightness value i, multiplying that (i.e., the value obtained by the calculating above) by the number of pixels H(i) of the corresponding brightness value i, adding that (i.e., the value obtained by the multiplying above) value to all brightness values, dividing by the total number of pixels N in the wafer image, and taking the square root of the result (i.e., the value obtained by the dividing above).

The contrast uniformity determination module 120 may determine the uniformity of the contrast distribution of a wafer image by comparing the value of the standard deviation calculated based on the histogram with a predetermined threshold value. In an embodiment, the contrast uniformity determination module 120 may determine that the contrast distribution of the wafer image is uniform when the value of the standard deviation is smaller than a threshold value. Alternatively, the contrast uniformity determination module 120 may determine that the contrast distribution of the wafer image is non-uniform if the value of the standard deviation is equal to or greater than the threshold value. The preprocessing module 130 performs preprocessing on the wafer image in a different manner by distinguishing between cases where the degree of staining is severe and cases where it is not based on the determination result of the contrast uniformity determination module 120, thereby making it possible to clarify the boundary between the scratch region and the non-scratch region even in a wafer image that includes stains.

In an embodiment, the preprocessing module 130 may perform image binarization on the wafer image when the contrast uniformity determination module 120 determines that the contrast distribution of the wafer image is uniform—that is, when the degree of staining in the wafer image is determined to be not severe. Image binarization may be the process of converting the pixel values of an image to white or black based on some threshold value. In an embodiment, for example, in a wafer image, pixels with a value greater than a certain threshold may be converted to white, and pixels with a value less than a certain threshold may be converted to black. This may simplify the complex information contained in the wafer image and facilitate edge extraction for detecting scratches.

In such an embodiment, the preprocessing module 130 may perform image equalization on the wafer image when the contrast distribution of the wafer image is determined to be non-uniform by the contrast uniformity determination module 120—that is, when the degree of staining in the wafer image is determined to be severe. Image equalization may improve the overall contrast of an image by making dark regions brighter and bright regions darker, thereby evenly distributing contrast. Accordingly, it may have a desired effect on edge detection for detecting scratches by highlighting details in heavily stained wafer images.

In some embodiments, when the contrast uniformity determination module 120 determines that the contrast distribution of the wafer image is non-uniform, the preprocessing module 130 may perform noise reduction on the wafer image before performing the image equalization. The noise reduction may be the removal or reduction of unnecessary noise from wafer images. In some embodiments, the preprocessing module 130 may perform bilateral filtering to reduce noise—that is, staining—from the wafer image while maintaining important structural information. Bilateral filtering reduces noise by averaging only on similar color pixels in the surrounding area, while preserving pixels with large color differences, so that overall noise may be effectively reduced while boundaries in wafer images remain sharp. To this end, bilateral filtering may be used to perform filtering based on the criterion that pixels further away from a center pixel have less influence on filtering, while pixels with colors similar to the center pixel have greater influence on filtering, and pixels with large color differences have less influence on filtering.

In some embodiments, the preprocessing module 130 may perform adaptive image binarization when the contrast distribution of the wafer image is determined to be uniform. In an embodiment, the preprocessing module 130 may detect n (where n is a natural number) detailed regions distinguished within the wafer image and perform image binarization on each of the n detailed regions. To this end, the preprocessing module 130 may obtain n local threshold values determined for each of n detailed regions, and perform image binarization for each of the n detailed regions based on the n local threshold values. Here, the local threshold value determined for each detailed region may be determined—for example, as a value calculated by calculating the average or Gaussian weighted average of pixel brightness in each detailed region. Adaptive image binarization allows more sophisticated processing by reflecting the different color distributions or degrees of staining within a single image than the general binarization method that uses a global threshold, and may be effective even in lighting changes or non-uniform lighting.

In some embodiments, the preprocessing module 130 may also automate the process of dividing detailed regions to perform adaptive image binarization. In an embodiment, the preprocessing module 130 may receive a predetermined first division variable and equally divide the wafer image based on the first division variable. In an embodiment, for example, if the value of the first division variable is 1, the wafer image may not be divided, and if the value of the first division variable is 4, the wafer image may be divided into four parts (2×2). The preprocessing module 130 may calculate the standard deviation of pixel brightness for each divided region, and determine each divided region as n detailed regions if the standard deviation of all divided regions is smaller than a predetermined threshold value. In contrast, if the standard deviation of any one of the divided regions is equal to or greater than the threshold value, the preprocessing module 130 may increase the value of the first division variable, divide the wafer image based on the first division variable with the increased value, and then recalculate the standard deviation of pixel brightness for each divided region. If the standard deviation of all newly divided regions is less than the threshold value, the preprocessing module 130 may determine each divided region into n detailed regions; otherwise, it may further increase the value of the first division variable and repeat the subsequent steps. By adopting the above automated detailed region division method, the reliability of adaptive image binarization may be ensured.

In an embodiment, for example, the preprocessing module 130 may calculate the standard deviation of pixel brightness of the wafer image when the value of the first division variable is 1, and perform image binarization on the entire wafer image when the standard deviation is less than a predetermined threshold value. In contrast, if the standard deviation is equal to or greater than a predetermined threshold, the preprocessing module 130 may increase the value of the first division variable by a constant (e.g., 4) times. Accordingly, the first division variable may be increased to 4.

In this case, the preprocessing module 130 may equally divide the wafer image based on the value of the first division variable, i.e., 4, and calculate the standard deviation of pixel brightness for each of the four divided regions. Next, the preprocessing module 130 may determine the four divided regions into n detailed regions if all four standard deviations corresponding to each of the four divided regions are less than a predetermined threshold value. In contrast, if any one of the four standard deviations is equal to or greater than a predetermined threshold value, the preprocessing module 130 may increase the value of the first division variable by a corresponding constant (e.g., 4) times. Accordingly, the first division variable may be increased to 16.

In this case, the preprocessing module 130 may equally divide the wafer image based on the value of the first division variable, i.e., 16, and calculate the standard deviation of pixel brightness for each of the sixteen divided regions. Next, the preprocessing module 130 may determine the sixteen divided regions into n detailed regions if all sixteen standard deviations corresponding to each of the sixteen divided regions are less than a predetermined threshold value. In contrast, if any one of the sixteen standard deviations is equal to or greater than a predetermined threshold value, the preprocessing module 130 may further increase the value of the first division variable and then repeat the subsequent steps.

In some embodiments, the preprocessing module 130 may perform adaptive image equalization if the contrast distribution of the wafer image is determined to be non-uniform. In an embodiment, the preprocessing module 130 may detect m (where m is a natural number) detailed regions distinguished within a wafer image and perform image equalization on each of the m detailed regions. To this end, the preprocessing module 130 may obtain m local threshold values determined for each of the m detailed regions, and perform image equalization for each of the m detailed regions based on the m local threshold values. Here, the local threshold value determined for each detailed region may be determined—for example, as a value calculated by calculating the average or Gaussian weighted average of pixel brightness in each detailed region. Adaptive image equalization allows more sophisticated processing by reflecting the different color distributions or degrees of staining within a single image than the general equalization method that uses a global threshold, and may be effective even when there are lighting changes or non-uniform lighting.

In some embodiments, the preprocessing module 130 may also automate the process of dividing detailed regions to perform adaptive image equalization. In an embodiment, the preprocessing module 130 may receive a predetermined second division variable and equally divide the wafer image based on the second division variable. In an embodiment, for example, if the value of the second division variable is 1, the wafer image may not be divided, and if the value of the second division variable is 4, the wafer image may be divided into four parts (2×2). The preprocessing module 130 may calculate the standard deviation of pixel brightness for each divided region, and determine each divided region as m detailed regions if the standard deviation of all divided regions is smaller than a predetermined threshold value. In contrast, if the standard deviation of any one of the divided regions is equal to or greater than the threshold value, the preprocessing module 130 may increase the value of the second division variable, divide the wafer image based on the second division variable with the increased value, and then recalculate the standard deviation of pixel brightness for each divided region. If the standard deviation of all newly divided regions is less than the threshold value, the preprocessing module 130 may determine each divided region into m detailed regions; otherwise, it may further increase the value of the second division variable, and subsequent steps may be repeated. By adopting the above automated detailed region division method, the reliability of adaptive image equalization may be ensured.

In an embodiment, for example, the preprocessing module 130 may calculate the standard deviation of pixel brightness of the wafer image when the value of the second division variable is 1, and perform image equalization on the entire wafer image when the standard deviation is less than a predetermined threshold value. In contrast, if the standard deviation is equal to or greater than a predetermined threshold, the preprocessing module 130 may increase the value of the second division variable by a constant (e.g., 4) times. Accordingly, the second division variable may be increased to 4.

In this case, the preprocessing module 130 may equally divide the wafer image based on the value of the second division variable, i.e., 4, and calculate the standard deviation of pixel brightness for each of the four divided regions. Next, the preprocessing module 130 may determine the four divided regions into m detailed regions if all four standard deviations corresponding to each of the four divided regions are less than a predetermined threshold value. In contrast, if any one of the four standard deviations is equal to or greater than a predetermined threshold value, the preprocessing module 130 may increase the value of the second division variable by a corresponding constant (e.g., 4) times. Accordingly, the second division variable may be increased to 16.

In this case, the preprocessing module 130 may equally divide the wafer image based on the value of the second division variable, i.e., 16, and calculate the standard deviation of pixel brightness for each of the sixteen divided regions. Next, the preprocessing module 130 may determine the sixteen divided regions into m detailed regions if all sixteen standard deviations corresponding to each of the sixteen divided regions are less than a predetermined threshold value. In contrast, if any one of the sixteen standard deviations is equal to or greater than a predetermined threshold value, the preprocessing module 130 may further increase the value of the second division variable and then repeat the subsequent steps.

The defect detection module 140 may perform edge detection on the wafer image on which the work of the preprocessing module 130 is completed to detect an edge pixel, and may perform line detection on the wafer image based on the edge pixel to detect a scratch on the surface of the wafer.

Edge detection may be the process of identifying the boundaries of objects—i.e., scratch regions—in a wafer image. An edge is a part of an image where brightness changes abruptly and may form a boundary separating scratch and non-scratch regions. In some embodiments, edge detection may be performed based on a gradient. In an embodiment, the gradient includes the magnitude and direction of brightness change in the wafer image, and since the value of the gradient is large in a part where there is an edge, edge detection may be performed using the gradient. The defect detection module 140 may calculate the gradient for each pixel of a wafer image and identify a point with a large gradient value as an edge pixel. in an embodiment, the defect detection module 140 may identify a point where the gradient value is equal to or greater than a predetermined gradient threshold as an edge pixel, and may identify a point where the gradient value is less than the gradient threshold as a non-edge pixel.

In some embodiments, edge detection based on a single gradient may be performed, which uses only a single gradient threshold to determine whether an edge pixel is present, or edge detection based on a variable gradient may be performed, which finds an appropriate gradient threshold while variably changing the gradient threshold and then performs edge detection.

In some embodiments, the defect detection module 140 may detect the edge pixel by performing edge detection based on a single gradient on the wafer image on which adaptive image binarization is performed and by performing edge detection based on a variable gradient on the wafer image on which adaptive image equalization is performed. Since the wafer image after adaptive image binarization is performed results in a black and white color separation, it may be sufficient to use only a single gradient threshold value when performing edge detection since the difference in shade is clear. However, when the wafer image on which adaptive image equalization is performed corresponds to a grayscale image, and the degree of difference in shade cannot be accurately known in grayscale images, it may be difficult to set a gradient threshold value. In this case, in a conventional method, users may manually set an appropriate gradient threshold value based on image characteristics. In an embodiment of the disclosure, the defect detection module 140 may first set a gradient threshold value to a small value for a grayscale wafer image on which adaptive image equalization has been performed, and then may gradually increase the gradient threshold value until the number of edge pixels detected as a result of edge detection falls within a predetermined limit value based on the corresponding gradient threshold value to perform edge detection without human intervention. Accordingly, the defect detection module 140 may determine an appropriate gradient threshold value in an automated manner.

The defect detection module 140 may perform line detection on the wafer image based on the edge pixel detected in the above manner. In an embodiment, the defect detection module 140 records the values of the distance from the origin point and the angle with the x-axis calculated for each detected edge pixel on an accumulator array, thereby detecting distances and angles that occur more frequently in a line. The defect detection module 140 may regard the detected line as a scratch that occurred on the surface of the wafer. In some embodiments, the defect detection module 140 may use the Hough transform to represent each edge pixel in parameter space for line detection and find whether the points may be combined to form a single line. Information about detected scratches may be stored in the form of a file in memory or a storage device, and may include information such as an original wafer image, intermediate images stored at each stage of defect detection, a final image showing scratches, and the number of detected scratches.

In some embodiments, the wafer image receiving module 110 may receive a wafer image including a plurality of partial images. That is, the plurality of partial images may be images obtained by dividing the wafer into a plurality of partial regions and capturing the plurality of partial regions. The contrast uniformity determination module 120 may determine the uniformity of contrast distribution for a first partial image among the plurality of partial images, and the preprocessing module 130 may perform image binarization on the first partial image when it is determined that the contrast distribution of the first partial image is uniform, and may perform image equalization on the first partial image when it is determined that the contrast distribution of the first partial image is non-uniform. Next, the defect detection module 140 may perform edge detection and line detection on the first partial image to detect the first scratch in the first partial image.

Next, the contrast uniformity determination module 120 may determine the uniformity of contrast distribution for a second partial image that is different from the first partial image among the plurality of partial images, and the preprocessing module 130 may perform image binarization on the second partial image when it is determined that the contrast distribution of the second partial image is uniform, and may perform image equalization on the second partial image when it is determined that the contrast distribution of the second partial image is non-uniform. Next, the defect detection module 140 may perform edge detection and line detection on the second partial image to detect a second scratch in the second partial image, and merge the first scratch and the second scratch to detect a scratch on the surface of the wafer.

In some embodiments, the preprocessing module 130 may detect n₁ (where n₁ is a natural number) detailed regions distinguished within the first partial image, and perform image binarization for each of the n₁ detailed regions based on n₁ local threshold values determined for each of the n₁ detailed regions to perform image binarization on the first partial image. In such embodiments, the preprocessing module 130 may detect n₂ (where n₂ is a natural number) detailed regions distinguished within the first partial image, and perform image binarization for each of the n₂ detailed regions based on n₂ local threshold values determined for each of the n₂ detailed regions to perform image binarization on the second partial image.

In some embodiments, the preprocessing module 130 may detect m₁ (where m₁ is a natural number) detailed regions distinguished within the first partial image, and perform image equalization for each of the m₁ detailed regions based on m₁ local threshold values determined for each of the m₁ detailed regions to perform image equalization on the first partial image. In such embodiments, the preprocessing module 130 may detect m₂ (where m₂ is a natural number) detailed regions distinguished within the second partial image, and perform image equalization for each of the m₂ detailed regions based on m₂ local threshold values determined for each of the m₂ detailed regions to perform image equalization on the second partial image.

In some embodiments, the preprocessing module 130 may perform noise reduction on the first partial image before performing image equalization on the first partial image when the contrast distribution of the first partial image is determined to be non-uniform. In such embodiments, the preprocessing module 130 may perform noise reduction on the second partial image before performing image equalization on the second partial image when the contrast distribution of the second partial image is determined to be non-uniform.

In some embodiments, the contrast uniformity determination module 120 may calculate pixel brightness for a pixel in the first partial image or the second partial image, generate a histogram representing frequency of values for the pixel brightness, and calculate the average and standard deviation for the pixel brightness based on the histogram. When the value of the standard deviation is less than a predetermined threshold value, the contrast uniformity determination module 120 may determine that the contrast distribution of the first partial image or the second partial image is uniform. In contrast, when the value of the standard deviation is equal to or greater than the threshold value, the contrast uniformity determination module 120 may determine that the contrast distribution of the first partial image or the second partial image is non-uniform.

In some embodiments, the defect detection module 140 may detect the first scratch based on an edge pixel obtained by performing edge detection based on a single gradient on the first partial image on which the image binarization is performed and by performing edge detection based on a variable gradient on the first partial image on which the image equalization is performed. In such embodiments, the defect detection module 140 may detect the second scratch based on an edge pixel obtained by performing edge detection based on a single gradient on the second partial image on which the image binarization is performed and by performing edge detection based on a variable gradient on the second partial image on which the image equalization is performed.

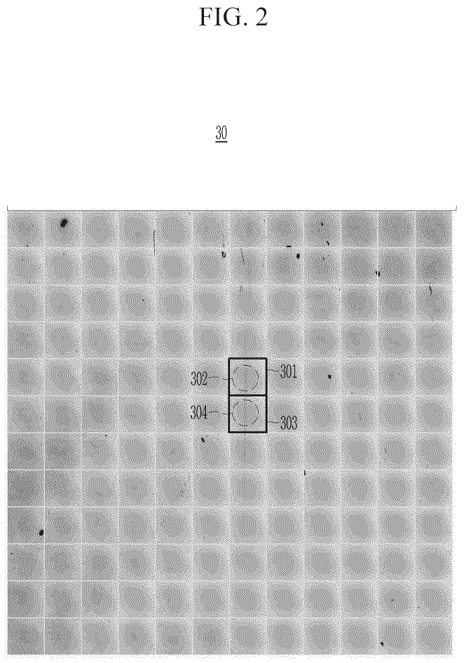

FIGS. 2 to 7 illustrate specific processes for detecting defects on a wafer surface according to embodiments.

Referring now to FIG. 2, a wafer image 30 received by the wafer image receiving module 110 is shown, where the wafer image is provided with 144 partial images obtained by dividing the wafer into 144 partial regions and capturing the 144 partial regions. As described above with respect to FIG. 1, the contrast uniformity determination module 120, the preprocessing module 130, and the defect detection module 140 may detect a first scratch 302 on a first partial image 301 among 144 partial images, detect a second scratch 304 on a second partial image 302 among 144 partial images, and then merge the first scratch 302 and the second scratch 304 located on the same line to detect a scratch on the surface of the wafer.

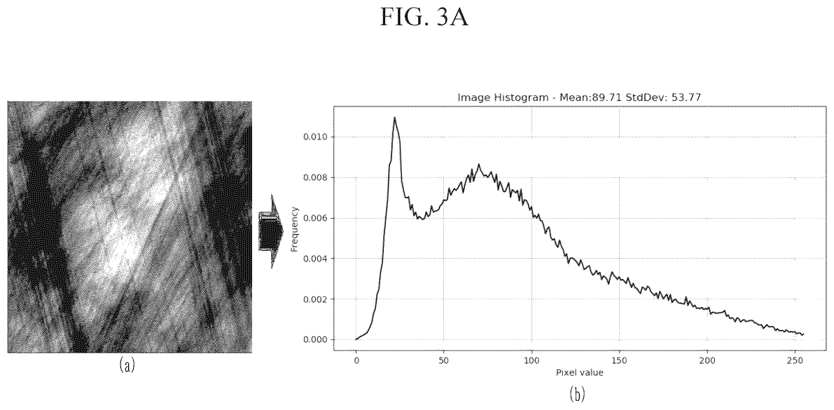

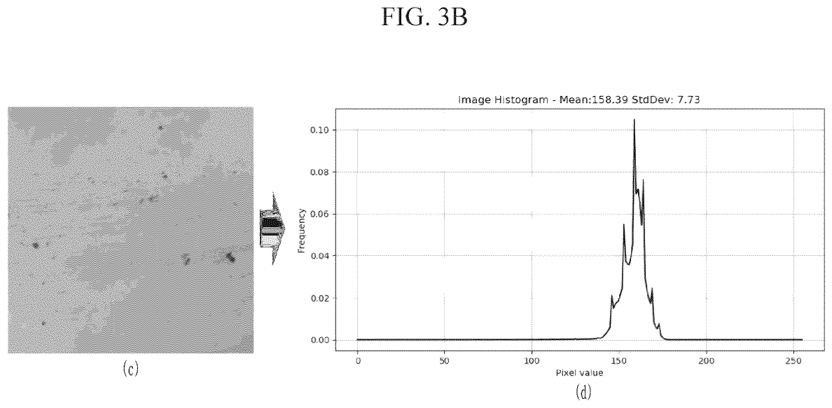

Referring to FIGS. 3A and 3B, an example of the contrast uniformity of a wafer image determined by the contrast uniformity determination module 120 is shown. It can be seen that in the case where the degree of staining in the wafer image is severe, as shown in (a) of FIG. 3A, the standard deviation value in the histogram showing the number of pixels corresponding to each contrast level in the wafer image, as shown in (b) of FIG. 3A, is a relatively high value of 53.77. In contrast, it can be seen that when the degree of staining in the wafer image is not severe, as shown in (c) of FIG. 3B, the standard deviation value in the histogram is relatively low at 7.73, as shown in (d) of FIG. 3B. Therefore, in the case of (c), image binarization may be applied, but in the case of (a), image binarization is difficult to apply, so image equalization may be desired to be applied.

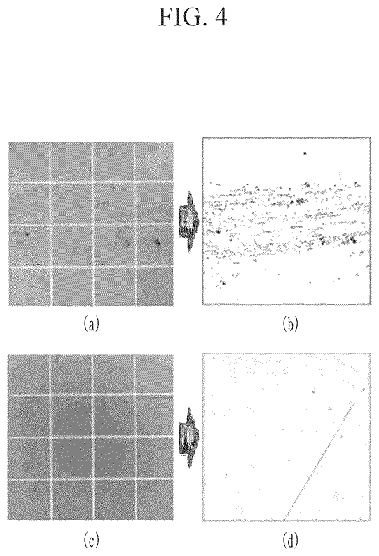

Referring to FIG. 4, the result of performing adaptive image binarization on a wafer image of (a) is shown in (b), and the result of performing adaptive image binarization on a wafer image of (c) is shown in (d). In both cases, it can be seen that the number of detailed regions to be distinguished within the wafer image to perform adaptive image binarization is 16.

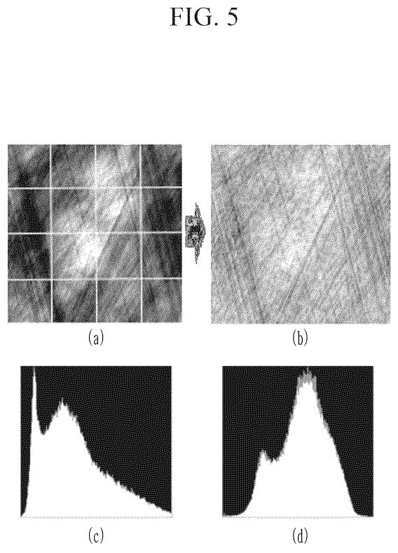

Referring to FIG. 5, the result of adaptive image equalization performed on a wafer image of (a) is shown in (b), and a histogram representing the pixel brightness distribution corresponding to (a) and a histogram representing the pixel brightness distribution corresponding to (b) are illustrated in (c) and (d), respectively. Here, the number of detailed regions separated within the wafer image to perform adaptive image equalization is 16, and it can be seen that the contrast is improved after adaptive image equalization.

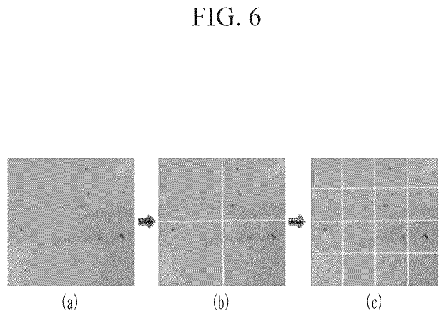

Referring to FIG. 6, an example is shown in which the process of separating detailed regions is performed automatically to perform adaptive image binarization or adaptive image equalization. It can be seen that in FIG. 6, (a) represents the case where the value of the first or second division variable is 1, (b) represents the case where the value of the first or second division variable is 4, and (c) represents the case where the value of the first or second division variable is 16.

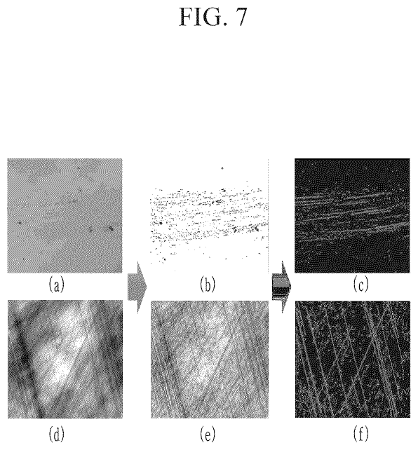

Referring to FIG. 7, it can be seen that the result of performing adaptive image binarization on the wafer image (a) with a less severe degree of staining is shown in (b), and the result of detecting scratches therefrom is shown in (c). Meanwhile, it can be seen that the result of performing adaptive image binarization on the wafer image (d) with a severe degree of staining is shown in (e), and the result of detecting scratches therefrom is shown in (f).

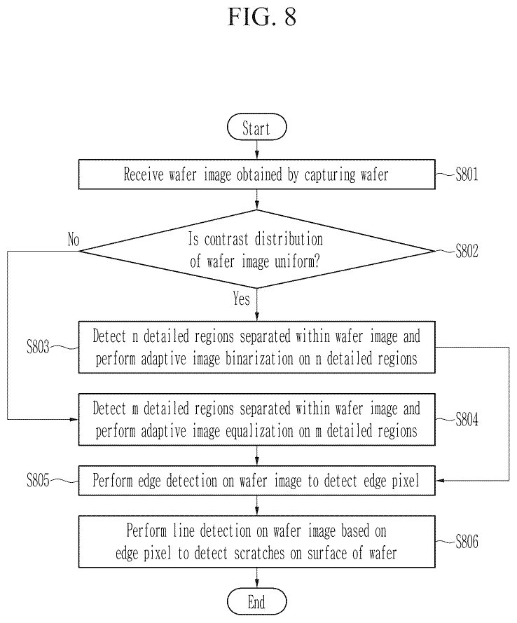

FIG. 8 illustrates a method for detecting defects on a wafer surface according to an embodiment.

Referring to FIG. 8, a method for detecting defects on a wafer surface according to an embodiment may include a process (S801) of receiving a wafer image obtained by capturing the wafer and a process (S802) of determining whether the contrast distribution of the wafer image is uniform.

If it is determined that the contrast distribution of the wafer image is uniform (S802, “Yes”), the method may perform a process (S803) of detecting n detailed regions distinguished within the wafer image and performing adaptive image binarization on the n detailed regions. In contrast, if it is determined that the contrast distribution of the wafer image is not uniform (S802, “No”), the method may perform a process (S804) of detecting m detailed regions separated within the wafer image and performing adaptive image equalization on the m detailed regions.

After performing the process S803 or the process S804, the method may perform a process (S805) of performing edge detection on the wafer image to detect an edge pixel and a process (S806) of performing line detection on the wafer image based on the edge pixel to detect scratches on the surface of the wafer.

Detailed features of the above method are substantially the same as those described above, and any repetitive detailed description thereof will be omitted.

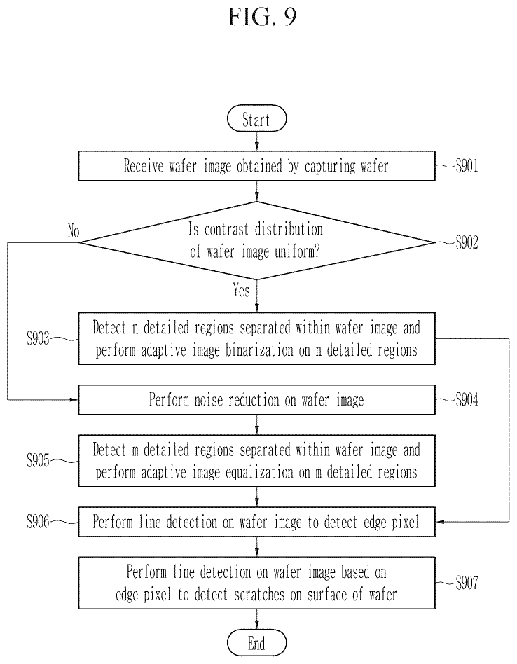

FIG. 9 illustrates a method for detecting defects on a wafer surface according to an embodiment.

Referring to FIG. 9, a method for detecting defects on a wafer surface according to an embodiment may include a process (S901) of receiving a wafer image obtained by photographing the wafer and a process (S902) of determining whether the contrast distribution of the wafer image is uniform.

If it is determined that the contrast distribution of the wafer image is uniform (S902, “Yes”), the method may perform a process (S903) of detecting n detailed regions distinguished within the wafer image and performing adaptive image binarization on the n detailed regions. In contrast, if it is determined that the contrast distribution of the wafer image is not uniform (S902, “No”), the method may perform a process (S904) of performing noise reduction on the wafer image and a process (S905) of detecting m detailed regions separated within the wafer image and performing adaptive image equalization on the m detailed regions.

After performing the process S903 or the process S905, the method may perform a process (S906) of performing edge detection on the wafer image to detect an edge pixel and a process (S907) of performing line detection on the wafer image based on the edge pixel to detect scratches on the surface of the wafer.

Detailed features of the above method are substantially the same as those described above, and any repetitive detailed description thereof will be omitted.

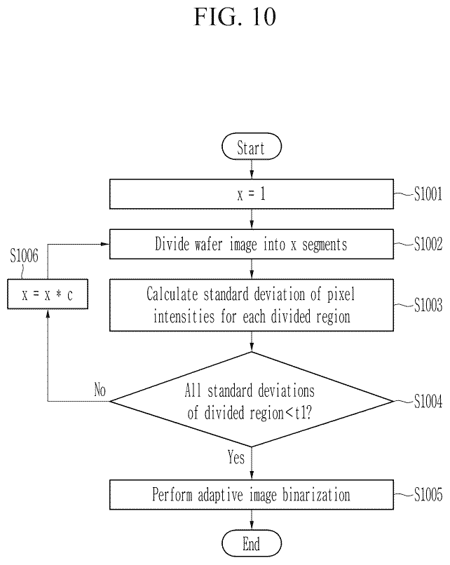

FIG. 10 illustrates a method for detecting defects on a wafer surface according to an embodiment.

Referring to FIG. 10, a method for detecting defects on a wafer surface according to an embodiment may include a process (S1001) of receiving a first division variable x initialized to 1, a process (S1003) of dividing a wafer image into x segments, a process (S1002) of calculating a standard deviation of pixel intensities for each divided region and a process (S1004) of determining whether all standard deviations of the divided regions are less than a predetermined threshold value t1.

If it is determined that all standard deviations of the divided region are less than the predetermined threshold value t1 (S1004, “Yes”), the method may perform a process (S1005) of performing adaptive image binarization. In contrast, if any one of all standard deviations of the divided region is determined to be equal to or greater than the predetermined threshold value t1 (S1004, “No”), the method may perform a process (S1006) of increasing the value of the first division variable x by multiplying a constant c and perform the process (S1002) again.

Detailed features of the above method are substantially the same as those described above, and any repetitive detailed description thereof will be omitted.

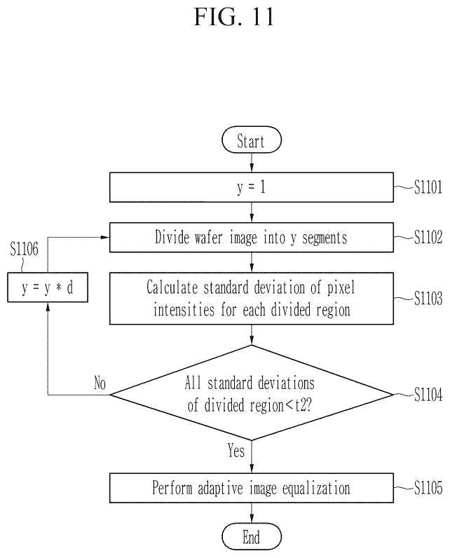

FIG. 11 illustrates a method for detecting defects on a wafer surface according to an embodiment.

Referring to FIG. 11, a method for detecting defects on a wafer surface according to an embodiment may include a process (S1101) of receiving a second division variable y initialized to 1, a process (S1102) of dividing a wafer image into y segments, a process (S1103) of calculating a standard deviation of pixel intensities for each divided region and a process (S1104) of determining whether all standard deviations of the divided regions are less than a predetermined threshold value t2.

If it is determined that all standard deviations of the divided region are less than the predetermined threshold value t2 (S1104, “Yes”), the method may perform a process (S1105) of performing adaptive image equalization. In contrast, if any one of all standard deviations of the divided region is determined to be equal to or greater than the predetermined threshold value t2 (S1104, “No”), the method may perform a process (S1106) of increasing the value of the second division variable y by multiplying a constant d and perform the process (S1002) again.

Detailed features of the above method are substantially the same as those described above, and any repetitive detailed description thereof will be omitted.

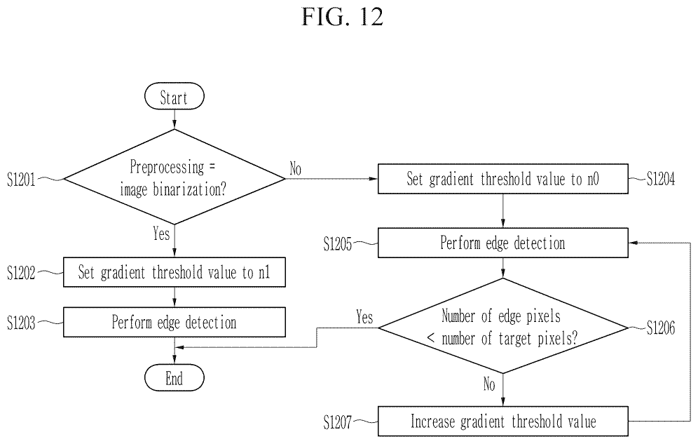

FIG. 12 illustrates a method for detecting defects on a wafer surface according to an embodiment.

Referring to FIG. 12, a method for detecting defects on a wafer surface according to an embodiment may include a process (S1201) of determining whether preprocessing performed on a wafer image is image binarization.

If it is determined that the preprocessing performed on the wafer image is image binarization (S1201, “Yes”), the method may perform a process (S1202) of setting the gradient threshold value to n1 and a process (S1203) of performing edge detection. In contrast, if it is determined that the preprocessing performed on the wafer image is not image binarization—i.e., image equalization (S1201, “No”)—the method may perform a process (S1204) of setting the gradient threshold value to no, a process (S1205) of performing edge detection and a process (S1206) of determining whether the number of edge pixels is less than a predetermined number of target pixels.

If it is determined that the number of edge pixels is not less than a predetermined number of target pixels, the method may perform a process (S1207) of increasing a gradient threshold value and perform the process (S1205) again.

Detailed features of the above method are substantially the same as those described above, and any repetitive detailed description thereof will be omitted.

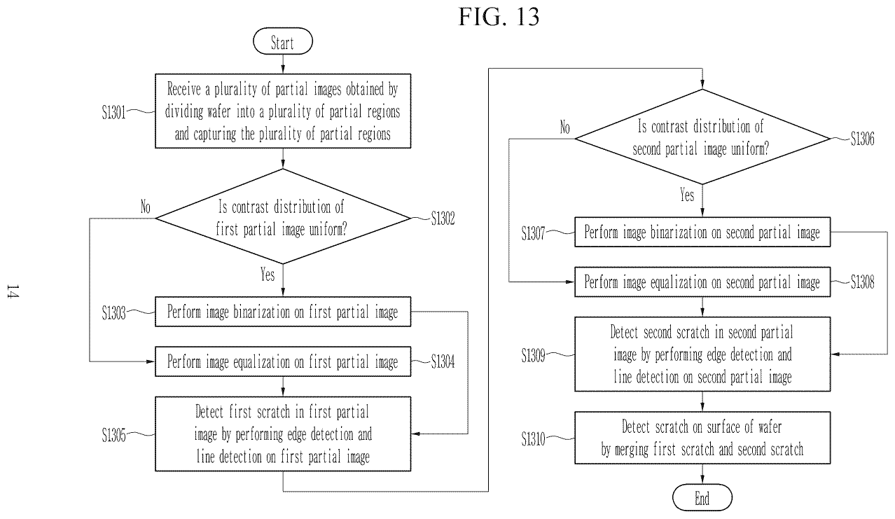

FIG. 13 illustrates a method for detecting defects on a wafer surface according to an embodiment.

Referring to FIG. 13, a method for detecting defects on a wafer surface according to an embodiment may include a process (S1301) of receiving a plurality of partial images obtained by dividing a wafer into a plurality of partial regions and capturing the plurality of partial regions, and a process (S1302) of determining whether the contrast distribution of the first partial image is uniform.

If it is determined that the contrast distribution of the first partial image is uniform (S1302, “Yes”), the method may perform a process (S1303) of performing image binarization on the first partial image. In contrast, if it is determined that the contrast distribution of the first partial image is not uniform (S1302, “No”), the method may perform a process (S1304) of performing image equalization on the first partial image.

After performing the process S1303 or the process S1304, the method may perform a process (S1305) of detecting a first scratch in the first partial image by performing edge detection and line detection on the first partial image and a process (S1306) of determining whether the contrast distribution of the second partial image is uniform.

If it is determined that the contrast distribution of the second partial image is uniform (S1306, “Yes”), the method may perform a process (S1307) of performing image binarization on the second partial image. In contrast, if it is determined that the contrast distribution of the second partial image is not uniform (S1306, “No”), the method may perform a process (S1308) of performing image equalization on the second partial image.

After performing the process S1307 or the process S1308, the method may perform a process (S1309) of detecting a second scratch in the second partial image by performing edge detection and line detection on the second partial image, and a process (S1310) of detecting a scratch on the surface of the wafer by merging the first scratch and the second scratch.

Detailed features of the above method are substantially the same as those described above, and any repetitive detailed description thereof will be omitted.

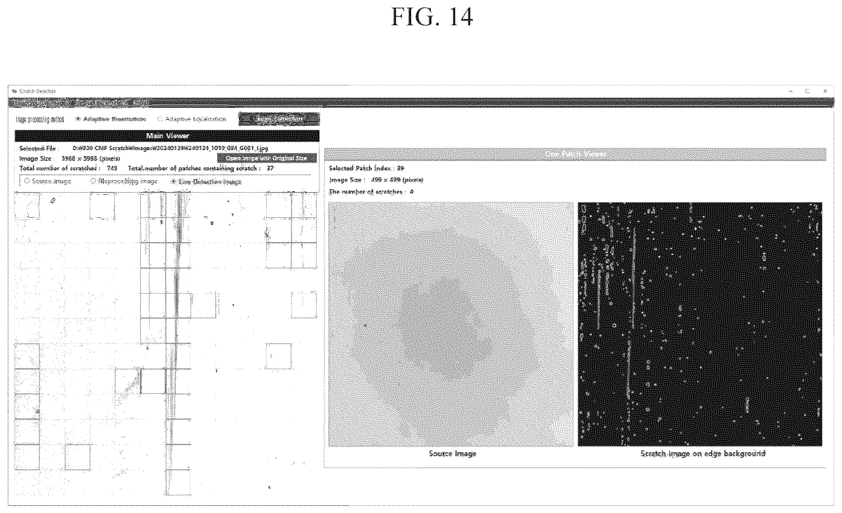

FIGS. 14 to 19 illustrate implementations of detecting defects on a wafer surface according to embodiments.

In FIG. 14, an example screen image showing an implementation of detecting defects on a wafer surface according to embodiments is shown. Here, a 12×12 electron microscope image d is input, and the scratch detection result is displayed as a red line overlaid on the original image or edge detection image. The region where a scratch is detected on the left side of the screen is represented by a red box, and the region selected by the user with the mouse among the 12×12 regions on the right side of the screen may be enlarged.

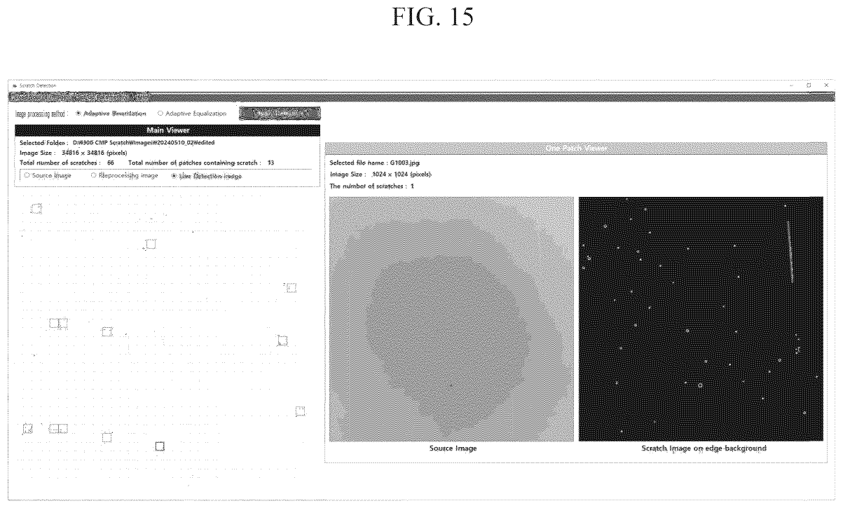

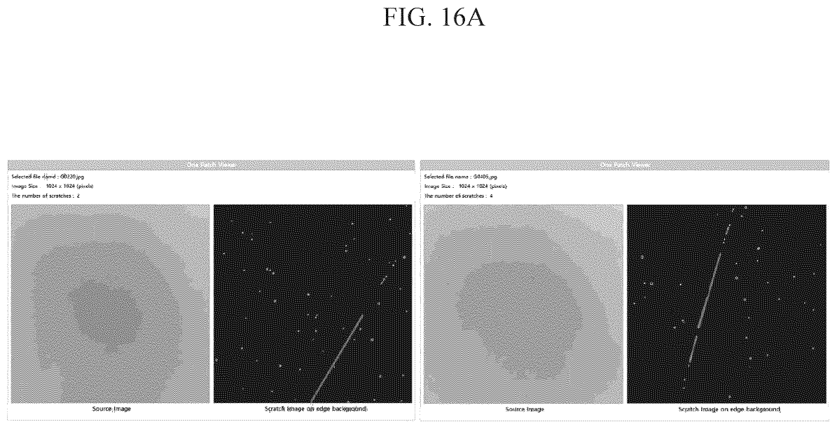

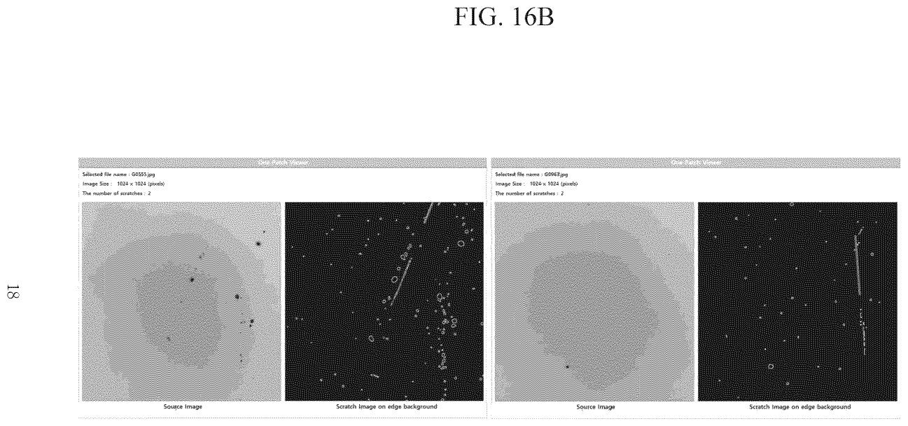

FIGS. 15, 16A, and 16B illustrate an example screen image of an implementation of detecting defects on a wafer surface in operation, where the total number of partial regions is 34×34=1156, the length of one side of the partial regions is 275 micrometers (μm), and the total area of the captured region is 9.4 millimeters (mm)×9.4 mm=87.4 square millimeters (mm²).

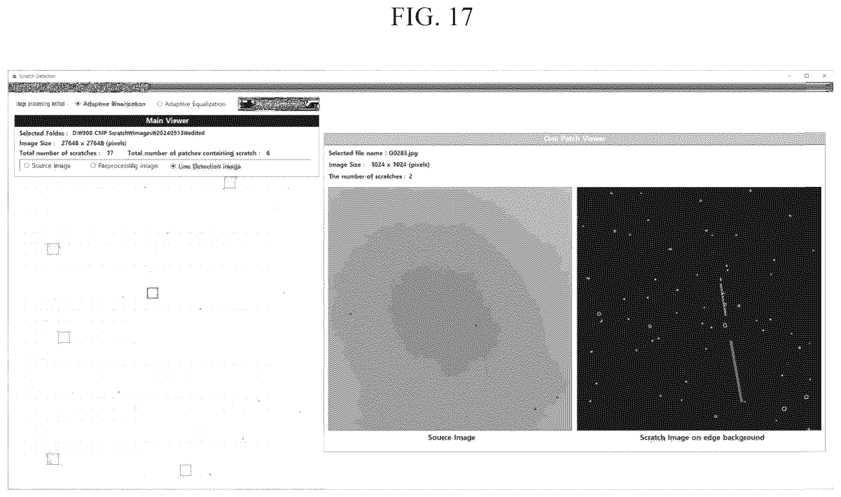

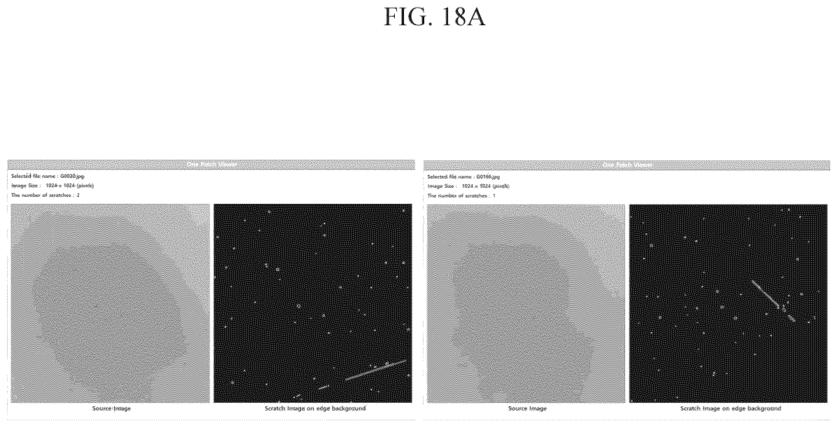

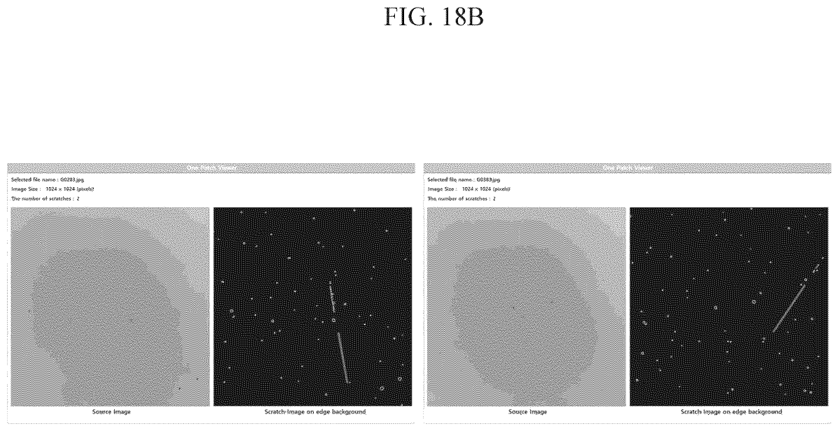

FIGS. 17, 18A, and 18B illustrate an exemplary screen of an implementation of detecting defects on a wafer surface in operation, where the number of total partial regions is 27×27=729, the length of one side of the partial regions is 275 μm, and the total area of the captured region is 7.4 mm×7.4 mm=55.1 mm².

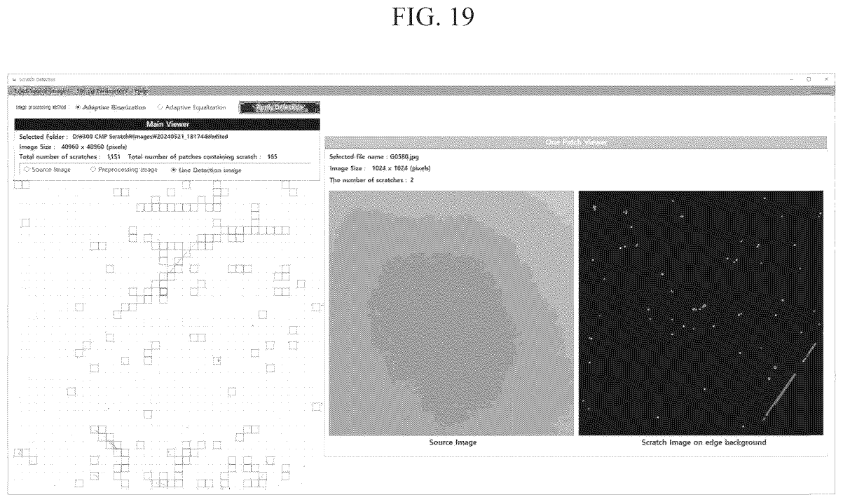

FIG. 19 illustrates an exemplary screen of an implementation of detecting defects on a wafer surface in operation, where the total number of partial regions is 40×40=1600, the length of one side of the partial regions is 275 μm, and the total area of the captured region is 11.0 mm×11.0 mm=121.0 mm².

FIG. 20 illustrates a computing device according to an embodiment.

Referring to FIG. 20, a method and device for detecting defects on a wafer surface according to embodiments may be implemented using a computing device 50. The computing device 50 may be implemented as various types of electronic devices, servers or similar devices, and its function may be implemented through a combination of software and hardware.

The computing device 50 may include at least one selected from the processor 510, a memory 530, a user interface input device 540, a user interface output device 550, and a storage device 560, which communicate with each other through a bus 520. The computing device 50 may also include a network interface 570 electrically connected to a network 40. The network interface 570 may transmit or receive signals to or from other entities through the network 40.

The processor 510 may be implemented as various types of calculation devices, such as a microcontroller unit (MCU), an application processor (AP), a central processing unit (CPU), a graphic processing unit (GPU), a neural processing unit (NPU) or a quantum processing unit (QPU), for example. The processor 510 is also a semiconductor device that executes instructions stored in the memory 530 or the storage device 560 and may play a key role in the system. Program codes or instructions and data stored in the memory 530 or the storage device 560 instruct the processor 510 to perform specific tasks, thereby enabling the overall operation of the system. The processor 510 may be configured to implement various functions and methods described above with respect to FIGS. 1 to 19.

The memory 530 and storage device 560 may include various forms of volatile or non-volatile storage medium for storing and accessing data of the system. In an embodiment, for example, the memory 530 may include a read-only memory (ROM) 531 and a random-access memory (RAM) 532. In some embodiments, the memory 530 may be built into the processor 510, in which case data transmission speeds between the memory 530 and the processor 510 may be very fast. In some other embodiments, the memory 530 may be disposed external to the processor 510, in which case the memory 530 may be connected to the processor 510 through various data buses or interfaces. This connection may be made through a variety of known means—for example, a peripheral component interconnect express (PCIe) interface for high-speed data transmission or a memory controller.

In some embodiments, at least some of the components or functions of the methods and devices for detecting defects on a wafer surface according to the embodiments may be implemented as a program or software executed on the computing device 50, and the program or software may be stored on a computer-readable medium. Specifically, a computer-readable medium, according to an embodiment, may record a program for executing steps included in an implementation of a method and device for detecting defects on a wafer surface according to embodiments, on a computer including the processor 510 executing a program or instructions stored in the memory 530 or the storage device 560.

In some embodiments, at least some of the components or functions of the methods and devices for detecting defects on a wafer surface according to the embodiments may be implemented using hardware or circuitry of the computing device 50, or may be implemented as separate hardware or circuit that may be electrically connected to the computing device 50.

According to embodiments, a method for automatically detecting scratches on a wafer surface by utilizing image processing and computer vision technologies is provided, thereby reducing human labor, shortening work time, and greatly improving overall efficiency. In addition, line-shaped scratches on the wafer that may occur during the CMP process may be automatically detected without user intervention, thereby improving the consistency and reliability of the production process. In addition, it is possible to effectively respond to subtle changes in contrast within an image, providing reliable detection results under various conditions. Further, the embodiments may be extended to detect line-shaped scratches occurring in products other than wafers, and thus may be utilized in various industrial fields.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A method for detecting defects on a wafer surface, the method comprising:
receiving a wafer image obtained by capturing a wafer in a grayscale or monochromatic expression;
determining a uniformity of contrast distribution of the wafer image;
detecting n detailed regions separated within the wafer image and performing adaptive image binarization on the n detailed regions when the contrast distribution of the wafer image is determined to be uniform, wherein n is a natural number;
detecting m detailed regions separated within the wafer image and performing adaptive image equalization on the m detailed regions when the contrast distribution of the wafer image is determined to be non-uniform, wherein m is a natural number;
performing edge detection on the wafer image to detect an edge pixel; and
performing line detection on the wafer image based on the edge pixel to detect a scratch on the surface of the wafer.

2. The method for detecting defects on the wafer surface of claim 1, wherein
the performing the adaptive image binarization comprises:
obtaining n local threshold values determined for each of the n detailed regions; and
performing image binarization for each of the n detailed regions based on the n local threshold values.

3. The method for detecting defects on the wafer surface of claim 2, wherein
the performing the adaptive image binarization further comprises:
receiving a first division variable having a predetermined value;
dividing the wafer image based on the first division variable having the predetermined value;
calculating a standard deviation of pixel brightness for each of divided regions of the wafer image divided based on the first division variable having the predetermined value; and
determining each of the divided regions as the n detailed regions when standard deviations of all of the divided regions of the wafer image divided based on the first division variable having the predetermined value is less than a predetermined first threshold value.

4. The method for detecting defects on the wafer surface of claim 3, wherein
the performing the adaptive image binarization further comprises:
increasing the value of the first division variable when the standard deviation of any one of the divided regions of the wafer image divided based on the first division variable having the predetermined value is equal to or greater than the first threshold value;
dividing the wafer image based on the first division variable having an increased value;
calculating the standard deviation of pixel brightness for each of divided regions of the wafer image divided based on the first division variable having the increased value; and
determining each of the divided regions into the n detailed regions when the standard deviations of all of the divided regions of the wafer image divided based on the first division variable having the increased value is less than the first threshold value.

5. The method for detecting defects on the wafer surface of claim 1, wherein
the performing the adaptive image equalization comprises:
obtaining m local threshold values determined for each of the m detailed regions; and
performing image equalization for each of the m detailed regions based on the m local threshold values.

6. The method for detecting defects on the wafer surface of claim 5, wherein
the performing the adaptive image equalization further comprises:
receiving a second division variable having a predetermined value;
dividing the wafer image equally based on the second division variable having the predetermined value;
calculating a standard deviation of pixel brightness for each of divided regions of the wafer image divided based on the second division variable having the predetermined value; and
determining each of the divided regions as the m detailed regions when standard deviations of all of the divided regions of the wafer image divided based on the second division variable having the predetermined value is less than a predetermined second threshold value.

7. The method for detecting defects on the wafer surface of claim 6, wherein
the performing the adaptive image equalization further comprises:
increasing the value of the second division variable when the standard deviation of any one of the divided regions of the wafer image based on the second division variable having the predetermined value is equal to or greater than the second threshold value;
dividing the wafer image based on the second division variable having an increased value;
calculating the standard deviation of pixel brightness for each of divided regions of the wafer image divided based on the second division variable having the increased value; and
determining each of the divided regions as the m detailed regions when the standard deviations of all of the divided regions of the wafer image divided based on the second division variable having the increased value is less than the predetermined second threshold value.

8. The method for detecting defects on the wafer surface of claim 1, further comprising:
performing noise reduction on the wafer image before the performing the adaptive image equalization when the contrast distribution of the wafer image is determined to be non-uniform.

9. The method for detecting defects on the water surface of claim 1, wherein
the determining the uniformity of contrast distribution of the wafer image comprises:
calculating pixel brightness for pixels in the wafer image;
generating a histogram representing frequency of values for the pixel brightness;
calculating an average and a standard deviation for the pixel brightness based on the histogram;
determining that the contrast distribution of the wafer image is uniform when a value of the standard deviation is less than a predetermined third threshold value; and
determining that the contrast distribution of the wafer image is non-uniform when the value of the standard deviation is equal to or greater than the third threshold value.

10. The method for detecting defects on the wafer surface of claim 1, wherein
the detecting the edge pixel comprises
detecting the edge pixel obtained by performing edge detection based on a single gradient on the wafer image, on which the adaptive image binarization is performed, and by performing edge detection based on a variable gradient, on the wafer image on which the adaptive image equalization is performed.

11. A method for detecting defects on a wafer surface, the method comprising:
receiving a plurality of partial images obtained by dividing a wafer into a plurality of partial regions and capturing the plurality of partial regions;
determining a uniformity of contrast distribution for a first partial image among the plurality of partial images;
performing image binarization on the first partial image when it is determined that the contrast distribution of the first partial image is uniform;
performing image equalization on the first partial image when it is determined that the contrast distribution of the first partial image is non-uniform;
performing edge detection and line detection on the first partial image to detect a first scratch in the first partial image;
determining a uniformity of contrast distribution for a second partial image different from the first partial image among the plurality of partial images;
performing the image binarization on the second partial image when it is determined that the contrast distribution of the second partial image is uniform;
performing the image equalization on the second partial image when it is determined that the contrast distribution of the second partial image is non-uniform;
performing the edge detection and the line detection on the second partial image to detect a second scratch in the second partial image; and
detecting a scratch on the surface of the wafer by merging the first scratch and the second scratch.

12. The method for detecting defects on the wafer surface of claim 11, wherein
the performing the image binarization on the first partial image comprises
detecting n₁ detailed regions separated within the first partial image and performing the image binarization for each of the n₁ detailed regions based on n₁ local threshold values determined for each of the n₁ detailed regions, wherein n₁ is a natural number, and
the performing the image binarization on the second partial image comprises
detecting n₂ detailed regions separated within the second partial image, and performing the image binarization for each of the n₂ detailed regions based on n₂ local threshold values determined for each of the n₂ detailed regions, wherein n₂ is a natural number.

13. The method for detecting defects on the wafer surface of claim 11, wherein
the performing the image equalization on the first partial image comprises
detecting m₁ detailed regions separated within the first partial image, and performing the image equalization for each of the m₁ detailed regions based on m₁ local threshold values determined for each of the m₁ detailed regions, wherein m₁ is a natural number, and
the performing the image equalization on the second partial image comprises
detecting m₂ detailed regions separated within the second partial image, and performing the image equalization for each of the m₂ detailed regions based on m₂ local threshold values determined for each of the m₂ detailed regions, wherein m₂ is a natural number.

14. The method for detecting defects on the wafer surface of claim 11, further comprising:
performing noise reduction on the first partial image before the performing the image equalization on the first partial image when the contrast distribution of the first partial image is determined to be non-uniform; and
performing noise reduction on the second partial image before the performing the image equalization on the second partial image when the contrast distribution of the second partial image is determined to be non-uniform.

15. The method for detecting defects on the wafer surface of claim 11, wherein
the determining the uniformity of contrast distribution of the wafer image comprises:
calculating pixel brightness for pixels in the first partial image or the second partial image;
generating a histogram representing frequency of values for the pixel brightness;
calculating an average and a standard deviation for the pixel brightness based on the histogram;
determining that the contrast distribution of the first partial image or the second partial image is uniform when a value of the standard deviation is less than a predetermined threshold value; and
determining that the contrast distribution of the first partial image or the second partial image is non-uniform when the value of the standard deviation is equal to or greater than the threshold value.

16. The method for detecting defects on the wafer surface of claim 11, wherein
the detecting the first scratch comprises
detecting the first scratch based on an edge pixel obtained by performing edge detection based on a single gradient on the first partial image, on which the image binarization is performed, and by performing edge detection based on a variable gradient on the first partial image, on which the image equalization is performed, and
the detecting the second scratch comprises
detecting the second scratch based on an edge pixel obtained by performing edge detection based on a single gradient on the second partial image, on which the image binarization is performed, and performing edge detection based on a variable gradient on the second partial image, on which the image equalization is performed.

17. A device which detects defects on a wafer surface, the device comprising:
one or more processors;
memory storing instructions that, when executed by the one or more processors, cause the device to:
receive a wafer image obtained by capturing a wafer in a grayscale or monochromatic expression;
determine a uniformity of the contrast distribution of the wafer image;
detect n detailed regions separated within the wafer image and perform adaptive image binarization on the n detailed regions when the contrast distribution of the wafer image is determined to be uniform, wherein n is a natural number;
detect m detailed regions separated within the wafer image and perform adaptive image equalization on the m detailed regions when the contrast distribution of the wafer image is determined to be non-uniform, wherein m is a natural number;
perform edge detection on the wafer image to detect an edge pixel; and
perform line detection on the wafer image based on the edge pixel to detect a scratch on the surface of the wafer.

18. The device which detects defects on the wafer surface of claim 17, wherein
the instructions, when executed by the one or more processors, further cause the device to perform noise reduction on the wafer image when the contrast distribution of the wafer image is determined to be non-uniform, before the adaptive image equalization is performed.

19. The device which detects defects on the wafer surface of claim 17, wherein
the uniformity of the contrast distribution is determined by:
calculating pixel brightness for pixels in the wafer image;
generating a histogram representing frequency of values for the pixel brightness;
calculating an average and a standard deviation for the pixel brightness based on the histogram;
determining that the contrast distribution of the wafer image is uniform when a value of the standard deviation is less than a predetermined third threshold value; and
determining that the contrast distribution of the wafer image is non-uniform when a value of the standard deviation is equal to or greater than the third threshold value.

20. The device which detects defects on the wafer surface of claim 17, wherein
the edge pixel is detected by performing the edge detection based on a single gradient on the wafer image, on which the adaptive image binarization is performed, and by performing the edge detection based on a variable gradient on the wafer image, on which the adaptive image equalization is performed.
